(19) United States
(12) Patent Application Publication
(10) Pub. No.: US 2024/0154345 A1
(43) Pub. Date: May 9, 2024

(54) TERMINAL INSERT, CONNECTOR AND SET

(71) Applicant: TE Connectivity India Private Limited, Bangalore (IN)

(72) Inventors: Vignesh Ravichandiran, Bangalore (IN); Tomas Svatek, Bangalore (IN); Miloslav Hlavinka, Bangalore (IN); Dharmendrajain Vedalaveni Parswanathaiah, Bangalore (IN)

(21) Appl. No.: 18/497,030

(22) Filed: Oct. 30, 2023

(30) Foreign Application Priority Data
Nov. 3, 2022 (IN) 202241062826

(51) Int. Cl. H01R 13/424

(52) U.S. Cl. CPC H01R 13/424; H01R 13/6592

(57) ABSTRACT

A terminal insert is provided for an unshielded cable that is configured to be inserted into an insert receptacle of a connector. The terminal insert includes an insert receptacle fitting section that is adapted to be fittingly received in at least a part of the insert receptacle, a terminal receptacle that is adapted to fittingly receive at least parts of a cable terminal, and a touch protection section at least at a first end, wherein the insert receptacle fitting section and the touch protection section are located on one monolithic piece. A connector is provided including at least one such terminal insert. A set is provided including the connector, at least one such terminal insert and a further terminal insert.

### CROSS REFERENCE TO RELATED APPLICATIONS

This application claims the benefit of IN Application No. 202241062826 filed 3 Nov. 2022, the subject matter of which is herein incorporated by reference in its entirety.

### BACKGROUND OF THE INVENTION

The subject matter herein relates to electrical connectors.

In certain applications, for example automotive applications, an easy assembly is important. The connectors used there often integrate wires with several diverse requirements, for example signal lines and power lines, or high voltage (HV) and low voltage (LV) lines.

A need remains for a connector that allows easy assembly.

### BRIEF DESCRIPTION OF THE INVENTION

In an embodiment, a terminal insert for an unshielded cable is provided. The terminal insert is configured to be inserted into an insert receptacle of the connector. The terminal insert includes an insert receptacle fitting section that is adapted to be fittingly received in at least a part of the insert receptacle. A terminal receptacle is adapted to fittingly receive at least parts of a cable terminal. A touch protection section is provided at least at a first end. The insert receptacle fitting section and the touch protection section are located on one monolithic piece.

In a further embodiment, a connector is provided including a terminal insert and an insert receptacle adapted to mate with the terminal insert and at least one further terminal insert. The further terminal insert is configured to be connected to a different cable, in particular a shielded cable.

In another embodiment, a set is provided including a connector having an insert receptacle, a terminal insert and a further terminal insert. The further terminal insert includes a shielding part that is configured to be connected to a shielding of a shielded cable. The cable receptacle is configured to receive selectively the terminal insert or the further terminal insert.

Previous insert terminals comprise several parts, where some parts, for example a touch protection, is made from plastic, and other parts, for example a shielding part, is made from a metal. Such previous terminal inserts are used independently of the fact whether a shielding is necessary in the connector. For example, power lines or power cables are connected via same insert terminals as signal lines although it is not necessary to shield them inside the connector. The subject matter herein allows the connection of such cables or lines without shielding by plugging them into the same insert receptacle in the connector as the previous insert terminals. Thus, the assembly is simplified. In addition, the assembly is further simplified as the number of parts is reduced vis-à-vis the previous terminal inserts.

The subject matter herein can further be improved by the following further developments and advantageous embodiments, which are independent of each other and can be combined arbitrarily, as desired.

In a development that allows a further simplification, the terminal receptacle is also located on the monolithic piece. Especially, the entire terminal insert can be a single monolithic (or synonymously one-piece or integral) piece.

The expression “fittingly received” here has to be understood as “being located in with minimal play and/or tolerances”. To achieve such a configuration, parts of a receiving element are preferably complementary to parts of the inserted element. Thus, the receiving element and the inserted element match each other at least in parts.

In a preferred embodiment, the terminal receptacle is substantially complementary to the parts of the cable terminal. This can result in a more stable connection and/or provide a sealing effect. Complementary in this context means that for example an inner face of the receiving element is shaped like the outer face of the inserted element.

The terminal insert can further comprise at least one terminal insert securing element for securing the terminal insert to the insert receptacle. The terminal insert securing element can fix the position or lock the terminal insert relative to the insert receptacle and thus the connector in particular along a terminal insert insertion direction along which the terminal insert is inserted into the insert receptacle. Preferably, the terminal insert securing element is located at the insert receptacle fitting section to achieve a good force flow.

Moreover, the terminal insert can further comprise at least one cable terminal securing element for securing the cable terminal to the terminal insert. Again, the cable terminal securing element can fix the position or lock the cable terminal relative to the terminal insert, in particular along a cable terminal insertion direction along which the cable terminal is inserted into the terminal insert. The cable terminal securing element is preferably located at the terminal receptacle to achieve a good mechanical connection.

The cable terminal can be made from a metal to achieve a good electrical connection. The cable terminal can comprise a cable receptacle adapted for receiving a cable. The cable and/or the terminal can be standardized according to at least one standard. Similarly, the insert receptacle can be standardized.

In the connector, the terminal insert and the further terminal insert are both configured to be secured or locked alternatively in the same insert receptacle.

In an embodiment that allows an easy assembly, at least one of the at least one terminal insert securing element or the at least one cable terminal securing element is a latching element.

According to one development, the latching element comprises an arm. This can result in a simple latching. The latching arm can extend away from or towards a second end opposite the first end. The latching arm can be located closer to the second end than to the first end, in particular the latching arm.

In a further embodiment, the latching arm extends towards the first end. At least one of the at least one terminal insert securing element or the at least one cable terminal securing element, in particular a base of the latching arm, may be fixed or located closer to the first end than to the second end.

The base of the latching arm of the terminal insert securing element can be located close to the second end. Close here means less than 10%, preferably less than 5% of the total length of the terminal insert. The length can in particular be measured along a terminal insert insertion direction and/or a cable terminal insertion direction.

To allow an easy and stable connection, the latching arm preferably extends along or counter to the cable terminal insertion direction and/or the terminal insert insertion direction.

According to one embodiment, the latching element of the terminal insert securing element comprises a latching protrusion protruding radially outwards to allow a simple mounting.

Similarly, the latching element of the cable terminal securing element can comprise a latching protrusion protruding radially inwards, in particular into a free inner space of the terminal receptacle.

The latching protrusion is, according to one embodiment, located at a free end of the latching arm to maximize the deflection height and/or minimize the force necessary for the deflection.

To allow an automatic latching, the latching protrusion can comprise an inclined deflection face. The inclined deflection face can be configured to automatically deflect the latching protrusion upon insertion of the terminal insert or the cable terminal, respectively.

The free end of the latching arm may be deflectable radially inwards and/or outwards.

“Radially” in this context refers to directions that are perpendicular to the cable terminal insertion direction and/or the terminal insert mounting direction.

The terminal insert can comprise more than one terminal insert securing element and/or more than one cable terminal securing element to increase the mechanical stability, in particular a pullout force necessary for forcefully separating the corresponding elements. To allow a good force distribution, the terminal insert securing elements and/or cable terminal securing elements can be distributed equally along a circumference of the terminal insert.

A compact configuration is possible, if the terminal insert securing element or the cable terminal securing element is integrated into a wall of the terminal insert. The terminal insert securing element and/or the cable terminal securing element can be basically flush with an enveloping shape of an outer or inner face of the terminal receptacle or the insert receptacle fitting section, respectively, except for a latching protrusion. This can in particular be the case in a relaxed state in which no force is applied to the respective securing element.

At least two terminal insert securing elements and/or two cable terminal securing elements can be offset along the cable terminal insertion direction and/or the terminal insert insertion direction. Such a solution can make the terminal insert more stable as recesses which are necessary for allowing a movement of the securing elements but which weaken the structure are distributed along the length, resulting in less weakening at one particular point of the length.

In one embodiment, at least two latching arms are present, one latching arm extending along and one extending counter to cable terminal mounting direction.

The terminal insert securing element and the cable terminal securing element can be offset along a circumferential direction. This can result in a more stable mounting of the assembly. In particular the terminal insert securing elements and cable terminal securing elements can be alternating, if pluralities of them are present. This can, for example, improve the vibration performance.

To achieve a good protection at the first end while allowing an insertion of a counter terminal, the touch protection comprises at least one protrusion protruding from the rest of the terminal insert along the terminal insert insertion direction. According to one embodiment, four such protrusions are present that are distributed equally around the circumference.

Preferably, the touch protection extends over most of or the entire terminal insert, at least when a cable is mounted to the terminal insert. This can maximize the safety for the user.

To allow an easy insertion, the terminal insert comprises in one embodiment a tapering insertion face at the first end. The insertion face can be truncated. The expression tapering of course relates to embodiments that taper towards the first end.

According to one embodiment that increases the safety further, the terminal insert comprises at least one coding element allowing the mounting of the terminal insert to the insert receptacle only in a single relative rotational angle. In order to allow a mounting with production or mounting tolerances, the single angle here has to be understood as relating to a small range that is substantially one angle, for example+/5°, preferably +/3°, especially+/1°.

To allow a safe interlocking with other parts of the connector, the coding element can protrude radially outwards.

According to one embodiment, the terminal insert comprises at least one spacing element adapted for spacing the other parts of the terminal insert from an inner wall of the insert receptacle. Such a spacing element can result in a defined insertion force and, for example, compensate tolerances in the sizes of the involved elements. Further, the spacing element can save material, as the wall does not have to be as thick as solutions having no spacing element. The spacing element preferably protrudes radially outwards to maximize the effect.

An outer face of the spacing element can be parallel to a terminal insert insertion direction. This can make the mounting easy. The outer face can be perpendicular to a radial direction to achieve a good guiding effect. The outer face can in particular be the outermost face or other face facing radially outwards.

In an alternative or in addition, at least parts of the spacing element can be adapted to act as a fixing element. Such a fixing element can be adapted for fixing the terminal insert in the insert receptacle and in particular be embodied as a clamping element. For example, the outer face can be inclined to the terminal insert insertion direction, for instance less than 10°, less than 5°, or less than 3°. Such an inclination can result in an automatic clamping or a pressing in during the insertion. For facilitating the insertion, a front face of the spacing element is preferably inclined to the terminal insert insertion direction.

According to one embodiment, the terminal insert comprises at least two spacing elements that center the cable terminal in at least one radial direction relative to the insert receptacle. The cable terminal can then be located centrally between the spacing elements and have a desired predefined position allowing a contacting of the mating terminals in a mating connector. If three or more spacing element are present, the terminal insert can be centered along two perpendicular radial directions.

To allow a simple assembly and achieve a stable mounting in the insert receptacle, the coding element and/or the spacing element can extend along the terminal insert insertion direction.

The coding element and/or the spacing element can be an elongated protrusion, for example with a ratio length/width greater than 5, preferably greater than 10, especially greater than 20 and/or a ratio length/maximum height greater than 5, preferably greater than 10, especially greater than 20. The coding element and/or the spacing element can be configured as a rail or a fin and/or can have a constant cross section along the terminal insert insertion direction.

If more than one spacing element is present, they should preferably be distributed equally along the circumference of the terminal insert.

According to one advantageous embodiment, the spacing elements come in closely spaced pairs. Such a configuration can have the advantage that the two spacing elements achieve a similar spacing effect as a single wider spacing element, but can be deformed more easily which lowers the force necessary for the insertion. Further, the pair of spacing elements can save material.

In one development, the terminal insert comprises a base body, the base body comprising a first tube section at which the terminal receptacle is located, and a second tube section at which at least a part of the insert receptacle fitting section is located. The tubular configuration can result in a mechanically stable but lightweight terminal insert.

To save material, the first tube section can have smaller outer dimensions than the second tube section.

Similarly, the first tube section can have smaller inner dimensions than the second tube section. Further, this can allow an easy mounting of the cable terminal through the second tube section.

For adapting to different requirements, the base body according to one development comprises a third tube section between the first tube section and the second tube section. At least a part of the insert receptacle fitting section can be located on the third tube section.

A particularly stable and compact configuration can be achieved when the first and/or the second tube section, and/or the third tube section, if present, are circular tubes. In this case, the outer or inner dimensions in particular relate to an outer or inner radius or diameter. The outer or inner dimensions of the third tube section can be between the outer or inner dimensions of the first tube section and the second tube section, to allow an easy insertion.

The base body can comprise at least one transition section connecting two tube sections, the transition section having at least one of an inclined outer face or an inclined inner face. This facilitates the insertion of the terminal insert into the insert receptacle and/or the insertion of the cable terminal into the terminal insert, respectively.

The spacing element can extend along the second tube section in order to be located in the insert receptacle fitting section. Further, the spacing element can extend along the third tube section to increase the length along which it engages a corresponding face in the insert receptacle, and thus to improve the mechanical stability. A good result should be achieved if the spacing element extends along at least 40%, preferably at least 50% of the length of the terminal insert. However, in order to allow the insertion through a small through-hole with no or little gaps, the spacing element should not extend along the first tube section.

To achieve a good mechanical fit, a length of the terminal receptacle should be at least ¼, preferably at least ⅓ of the length of the cable terminal.

Similarly, a length of the insert receptacle fitting section should be at least ¼, preferably at least ⅓ of the length of the cable terminal.

The terminal insert can comprise a stop face facing in the terminal insert insertion direction. The stop face may be adapted for engaging a counter stop face on the connector to block a movement of the terminal insert into the insert receptacle beyond a defined relative position.

In a material-saving configuration, the stop face is at least in parts located on the spacing element. Several parts of the stop face can be located on two spacing elements, preferably bridging two spacing elements, which results in an additional mutual support of the two spacing elements. The stop face is preferably located close to the second end.

As in the rest of the text, the expression “located on” may in particular mean “being a part of”.

In order to save weight, the terminal insert may be made from a plastic material, for example from a moldable plastic material.

The first end can be a connection side end, i.e. a side where a connection to a mating connector is made. Such an end can also be named a distal end.

The second end can be a cable side end, i.e. an end where the cable enters the terminal insert. Such an end can be named a proximal end.

In an embodiment that allows a good force distribution, the terminal insert has an n-fold rotational symmetry except for the coding element, meaning that after a rotation of 360°/n the terminal insert has the same shape. n should be 3 or greater and/or less than 12, preferably less than 8.

According to one embodiment, the terminal receptacle is located closer to the first end than the insert receptacle fitting section.

The cable terminal insertion direction is preferably parallel to the terminal insert insertion direction to simplify the mounting process.

Further part of the connector and/or the cable terminal can comprise corresponding counter elements to the elements of the terminal insert, for example counter latching elements or counter securing elements adapted for cooperating with the latching elements or securing elements of the terminal insert.

The parameters for the touch protection can be defined by a standard. As in the rest of the text, standard refers to a national, international, company, industry, or consortium standard. The touch protection standard can include the definition of a test finger resembling a human finger.

The connector and/or the set can further comprise at least one cable terminal. The insert and the further insert terminal can be configured to receive the same cable terminal.

The further insert terminal can in particular be a multipiece insert terminal, especially comprising parts being made from at least two different materials.

The connector can be a high-voltage or high-power connector.

The connector can be shielded, in particular also in regions where no shielding is necessary, in particular around an insert receptacle intended for the insertion of the terminal insert.

The subject matter herein is described as being used together with an unshielded cable. However, the cable to which the terminal insert is connected can also be a shielded cable. The shielding can, for example, be removed at least in parts where it is connected to the cable terminal.

Embodiment are described in greater detail and in an exemplary manner using advantageous embodiments and with reference to the drawings. The described embodiments are only possible configurations, in which, however, the individual features as described above can be provided independently of one another or can be omitted.

### BRIEF DESCRIPTION OF THE DRAWINGS

FIG. 1 shows a schematic perspective, partially cut view of a set in accordance with an exemplary embodiment.

FIG. 2 shows a schematic perspective view of a terminal insert used in FIG. 1 in accordance with an exemplary embodiment.

FIG. 3 shows a schematic, partially cut top view of the set of FIG. 1 in accordance with an exemplary embodiment.

FIG. 4 shows a schematic front view of details of the connector of FIG. 1 with two terminal insert in accordance with an exemplary embodiment.

FIG. 5 shows a schematic cross-sectional front view of details of the connector of FIG. 1 with two terminal inserts in accordance with an exemplary embodiment.

FIG. 6 shows a schematic perspective view of a terminal insert in accordance with an exemplary embodiment.

FIG. 7 shows another schematic perspective view of the terminal insert of FIG. 6 in accordance with an exemplary embodiment.

### DETAILED DESCRIPTION OF THE INVENTION

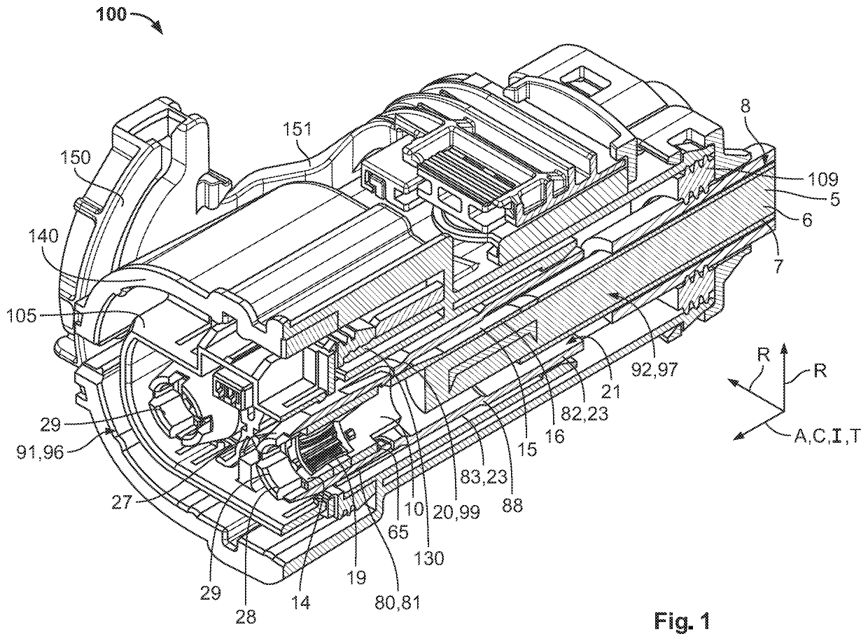

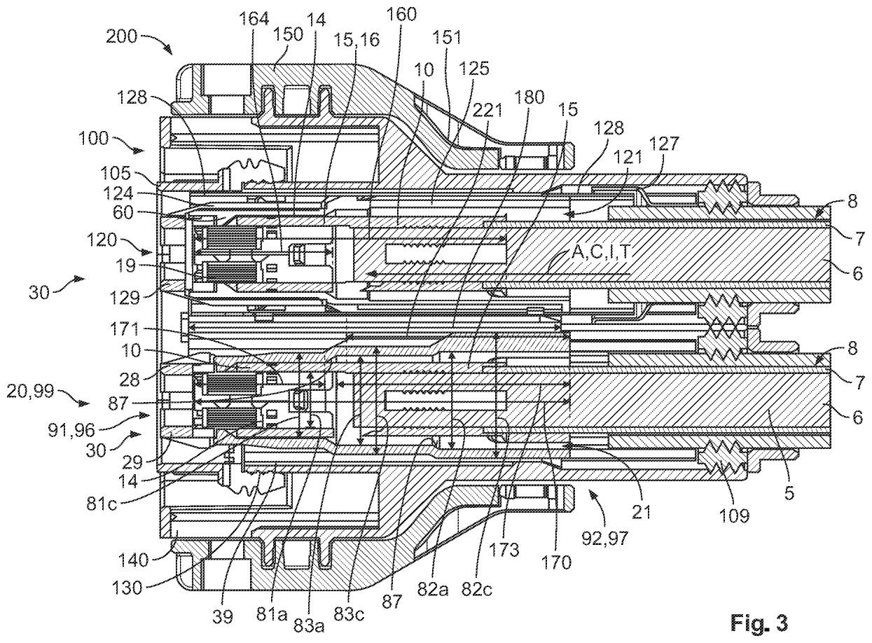

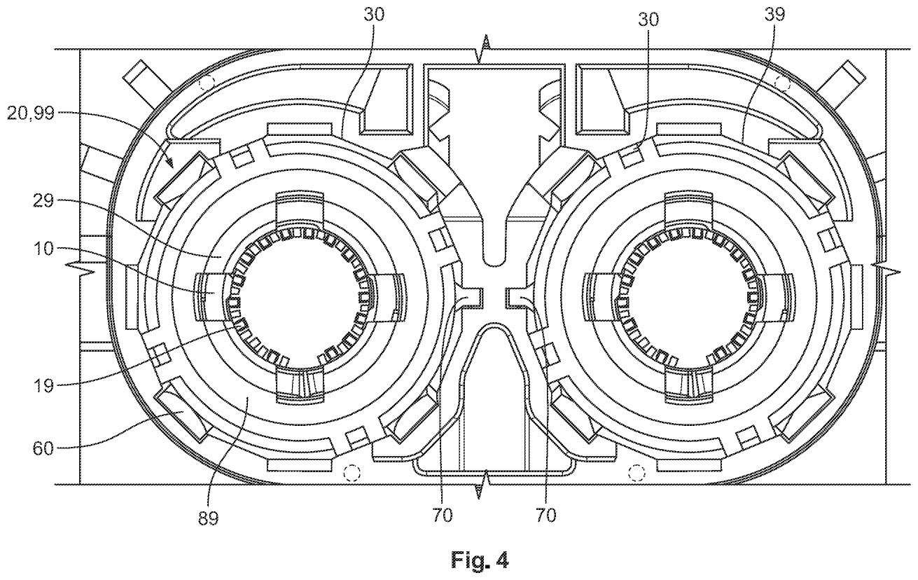

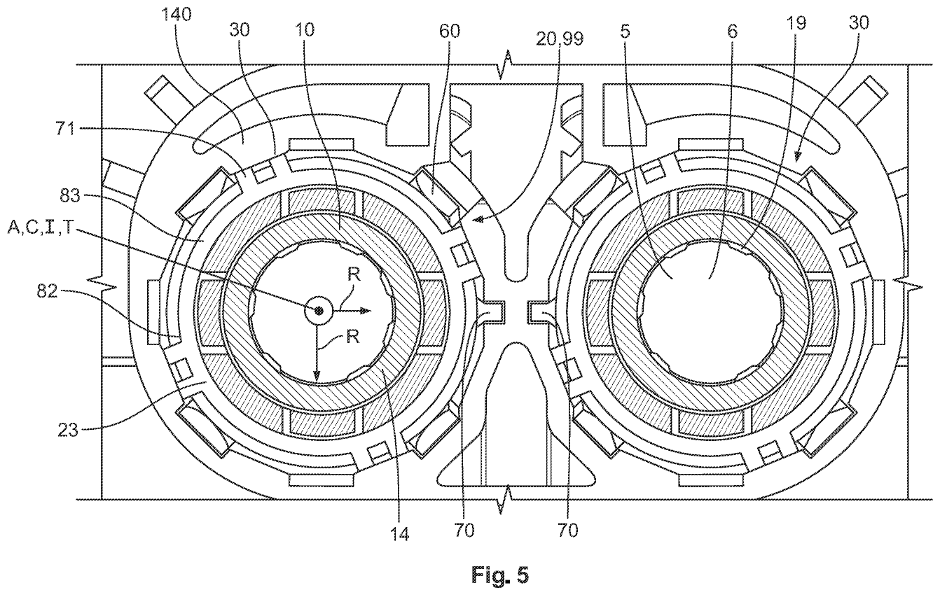

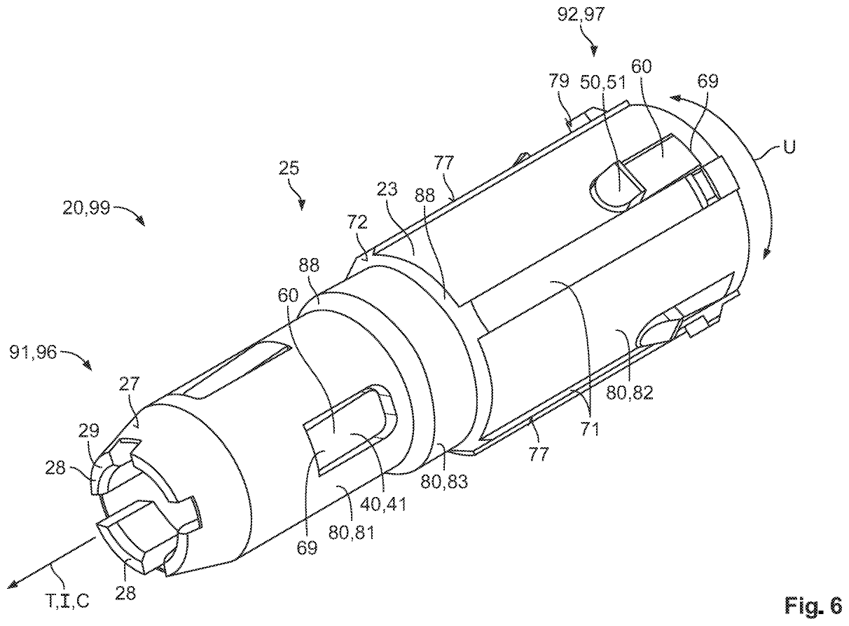

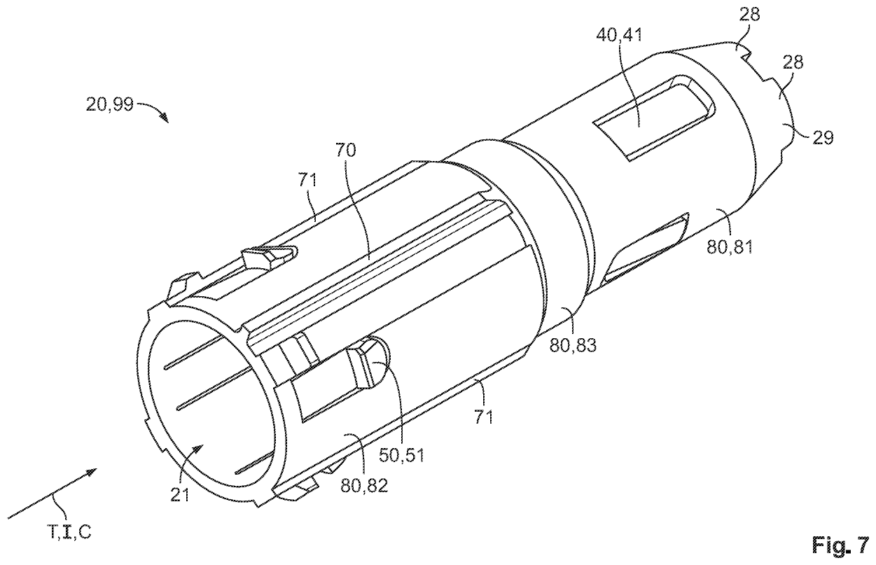

In the FIGS. 1 to 5, an embodiment of a terminal insert 20 is depicted. In FIGS. 6 and 7, an alternative embodiment of the terminal insert 20 is shown. Further, FIGS. 1 to 5 show a connector 100 having several insert receptacles 30. The insert receptacles 30 have a similar inner structure. In FIGS. 1, 5 and 6, two terminal inserts 20 are located in the insert receptacle 30. In FIG. 3, the terminal insert 20 is located in the lower insert receptacle 30, while in the upper insert receptacle 30, a further or second terminal insert 120 according to a previous solution is located. The terminal insert 20 and the further terminal insert 120 can be interchangeably located in each of the insert receptacles 30.

The further terminal insert 120 is shielded. The further terminal insert 120 comprises a shielding part 128 made from a metal that can be connected to a shielding 8 of a cable 5 with a connection element 127, for example by crimping, welding or soldering. The further terminal insert 120 comprises two further parts 124, 125 made from a plastic material. The shielding part 128 surrounds the two further parts 124, 125 and locks the further terminal insert 120 in the insert receptacle 30. On the first part 124, a touch protection section 129 is present. A cable terminal 10 is received in a terminal receptacle 121. This further terminal insert 120 is configured for making a connection to a shielded cable 5. However, it is difficult to assemble and relatively heavy due to the metal.

In order to connect a cable 5 that does not need to be shielded within the connector 100 with less assembly work, the terminal insert 20 is made from a single monolithic piece 99. The terminal insert 20 does not have any shielding part that would be connected to the shielding 8 of the cable 5. Rather, only the inner conductor 6 of the cable 5 is connected to the cable terminal 10, in particular to a conductor connection section 15, which is configured as a crimping section 16. The inner conductor 6 is surrounded by an insulation 7, which is in turn surrounded by the shielding 8. The terminal insert 20 can also be used together with an unshielded cable.

The connector 100 can be connected to a mating connector (not depicted). For a matching of the plugging faces, a front piece 105 is present on the connector 100. The connector 100 comprises a locking mechanism 150 for locking the connector 100 to the mating connector. The locking mechanism 150 comprises in particular a lever 151. For receiving a mating terminal of the mating connector, the cable terminals 10 comprise mating terminal receptacles 14 which have elastic cages 19 for achieving a good electrical contact.

Each terminal insert 20 is configured to be inserted into one insert receptacle 30 of the connector 100. The terminal insert 20 in particular comprises an insert receptacle fitting section 23 that is adapted to be fittingly received in at least a part of the insert receptacle 30. In the depicted embodiments, spacing elements 71 that protrudes radially outwards achieve the fitting reception or matching within the insert receptacle 30. Outer faces 77 of the spacing elements 71 contact an inner wall 39 of the insert receptacle 30.

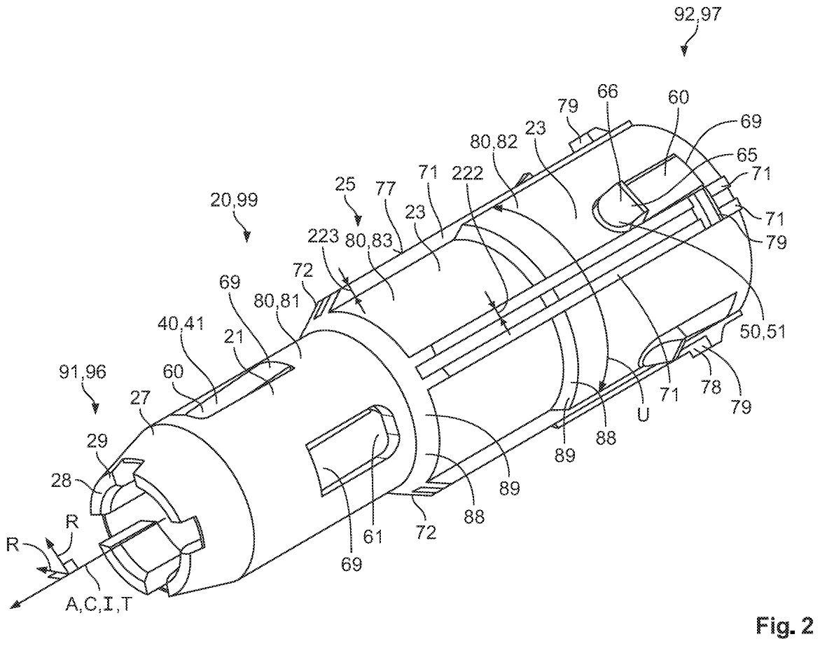

The terminal insert 20 in FIG. 2 comprises pairs of neighboring spacing element 71, the pairs being distributed equally along a circumferential direction U of the terminal insert 20. The depicted embodiment comprises four pairs of spacing elements 71 that allow a centering of the cable terminal 10 in the insert receptacle 30 along two perpendicular radial directions R. The spacing between two spacing elements 71 in one pair can for example be less than four times a width 222 of the spacing elements 71.

Alternatively, the terminal insert 20 may comprise solitary spacing element 71, which are distributed equally along the circumferential direction U as depicted in FIG. 6.

The terminal insert 20 further comprises a terminal receptacle 21 that is adapted to fittingly receive at least parts of a cable terminal 10. The embodiment shows that the terminal receptacle 21 has a length 171 that is approximately 90% of the length 164 of the mating terminal receptacle 14, resulting in good mechanical stability. In this embodiment, the terminal receptacle 21 is complimentary to the mating terminal receptacle 14 of the cable terminal 10 to achieve a high stability.

To achieve a good mechanical fit, the length 171 of the terminal receptacle 21 should be at least ¼, preferably at least ⅓ of the length 160 of the cable terminal 10.

Similarly, a length 173 of the insert receptacle fitting section 23 should be at least ¼, preferably at least ⅓ of the length 160 of the cable terminal 10.

At a first end 91, the terminal insert 20 comprises a touch protection section 29 to prohibit the access to voltage carrying parts of the cable terminal 10 by a user. Almost the entire surface of the cable terminal 10 is surrounded by the plastic material of the terminal 20 except for of course parts where the mating terminal and the cable 5 are supposed to enter the terminal insert 20.

The insert receptacle fitting section 23 and the touch protection section 29 are located on one monolithic piece 99. Moreover, the terminal receptacle 21 is also a part of the monolithic piece 99. The terminal receptacle 21 is a single integral piece.

The terminal insert 20 further comprises terminal insert securing elements 50 located at the insert receptacle fitting section 23 for securing the terminal insert 20 to the insert receptacle 30.

In addition, the terminal insert 20 comprises several cable terminal securing elements 40 located at the terminal receptacle 21 for securing the cable terminal 10 to the terminal insert 20.

The terminal insert securing elements 50 and the cable terminal securing elements 40 are embodied as latching elements 51, 41 that due to inclined deflection faces 66 automatically achieve a latching and securing when the cable terminal 10 is inserted into the terminal receptacle 21 along a cable terminal insertion direction T or the terminal insert 20 is inserted into the insert receptacle 30 along a terminal insert insertion direction I, respectively.

Each latching element 41, 51 comprises a latching arm 60 that extends from a base 69 along or counter to the cable terminal insertion direction T and/or the terminal insert insertion direction I. In the depicted embodiment, the cable terminal insertion direction T and the terminal insert section direction I are parallel to each other and parallel to an axial direction A along which the terminal insert 20 extends. They are further parallel to a cable insertion direction C along which the cable extends into the terminal insert 20 and the connector 100. The radial directions R are perpendicular to the axial direction A.

Some latching arms 60 extend away from a second end 92 opposite the first end 91, while other latching arms 60 extends towards the second end 92.

The terminal insert securing elements 50 are located closer to the second end 92 than to the first end 91. The cable terminal securing elements 40 are located closer to the first end 91 than to the second end 92.

Latching protrusions 65 are located on the free ends 61 of the latching arms 60 and protrude radially outwards or inwards depending on the respective requirements. In particular, latching element 41 of the cable terminal securing element 40 comprise latching protrusion 65 protruding into the empty inner space defined by the terminal receptacle section 21.

The terminal insert securing element 50 and the cable terminal securing element 40 are distributed equally along the circumferential direction U. The terminal insert securing element 50 and the cable terminal securing element 40 are offset along the circumferential direction U. They are arranged in an alternating manner in order to achieve a good vibration behavior.

The terminal insert securing elements 50 and the cable terminal securing element 40 are integrated into a wall of the terminal insert 20. Except for the latching protrusions 65, they are basically flush with an enveloping shape of outer and inner faces of the terminal insert 20, at least in a relaxed, force free state.

The touch protection section 29 comprises four protrusions 28 protruding from the rest of the terminal insert 20 along the terminal insert insertion direction I.

To allow an easy insertion, the terminal insert 20 comprises a tapering insertion face 27 at the first end 91. In the depicted embodiment, the insertion face 27 is truncated, namely frustro-conical.

The first end 91 is a connection side end 96, at which the connector 100 is connected to the mating connector. The second end 92 is a cable side end 97, at which the cable 5 enters the terminal insert 20.

Each terminal insert 20 has one coding element 70 in order to ensure that the terminal insert 20 can be inserted into the insert receptacle 30 only at a single relative rotational angle.

Like the spacing elements 71, the coding element 70 protrudes radially outwards (see FIG. 7).

The coding element 70 and the spacing element 71 extend along the terminal insert insertion direction I. They are elongated protrusions having a high ratio of their length 221 to their width 222 and a high ratio of their length 221 to their maximum height 223. They are configured as rails or fins, and have a constant cross section along the terminal insert insertion direction I.

A front face 72 of the spacing element 71 is inclined to the terminal insert insertion direction I.

The terminal insert 20 comprises a base body 25, the base body 25 comprising a first tube section 80, 81 at which the terminal receptacle 21 is located and a second tube section 80, 82 at which a part of the insert receptacle fitting section 23 is located. A further part of the insert receptacle fitting section 23 is located on a third tube section 80, 83 arranged between the first tube section 80, 81 and second tube section 80, 82.

The first tube section 80, 81 has smaller inner and outer dimensions than the third tube section 80, 83, which in turn has smaller inner and outer dimensions than the second tube section 80, 82. The tube sections 80 are configured as circular tubes, so that the inner and outer dimensions relate to inner diameters 81a, 82a, 83a and outer diameters 81c, 82c, 83c.

The base body 25 comprises two transition sections 88, each connecting two tube sections 80, the transition sections 88 having inclined outer faces 89 and inclined inner faces 87 to facilitate the mounting process.

To achieve a good mechanical fit, the spacing elements 71 extend basically along the second tube section 82 and the 3rd tube section 83, i.e. along almost the entire insert receptacle fitting section 23 (see FIG. 2). Alternatively, the spacing elements 71 only extend along the second tube section 82 in order to save material (see FIG. 6). However, they do not extend along the first tube section 81. They can extend along at least 40%, preferably at least 50% of a length 170 of the terminal insert 20 and preferably along at least 40%, preferably at least 50% of a length 180 of the insert receptacle 30.

A stop face 79 that is facing in the terminal insert insertion direction I and that is adapted for engaging a counter stop face on the connector 100 blocks the movement of the terminal insert 20 beyond a desired position. The stop face 79 is in parts located on two neighboring spacing element 71 and is designed as a bridging element 78 resulting in additional mutual support between the two spacing elements 71.

The embodiment of a terminal insert 20 shown herein has a 4fold rotational symmetry except for the coding element 70.

The connector 100 has a housing 140 that is simultaneously a base element 130. In the housing, in particular in each insert receptacle 30, a seal 109 may be provided in order to prevent the ingress of water and other contaminants.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A terminal insert for an unshielded cable, the terminal insert being configured to be inserted into an insert receptacle of a connector, the terminal insert comprising:
an insert receptacle fitting section that is adapted to be fittingly received in at least a part of the insert receptacle,
a terminal receptacle that is adapted to fittingly receive at least parts of a cable terminal, and
a touch protection section at least at a first end,
wherein the insert receptacle fitting section and the touch protection section are located on one monolithic piece.

2. The terminal insert according to claim 1, wherein the terminal receptacle is substantially complementary to the parts of the cable terminal.

3. The terminal insert according to claim 1, wherein the terminal receptacle is also located on the monolithic piece.

4. The terminal insert according to claim 1, wherein the terminal insert further comprises at least one terminal insert securing element for securing the terminal insert to the insert receptacle.

5. The terminal insert according to claim 1, wherein the terminal insert further comprises at least one cable terminal securing element for securing the cable terminal to the terminal insert.

6. The terminal insert according to claim 1, wherein the terminal insert further comprises at least one terminal insert securing element for securing the terminal insert to the insert receptacle and at least one cable terminal securing element for securing the cable terminal to the terminal insert, wherein at least one of the at least one terminal insert securing element and the at least one cable terminal securing element is a latching element.

7. The terminal insert according to claim 1, wherein the terminal insert comprises at least one spacing element adapted for spacing the remainder of the terminal insert from an inner wall of the insert receptacle.

8. The terminal insert according to claim 7, wherein an outer face of the spacing element is parallel to a terminal insert insertion direction.

9. The terminal insert according to claim 7, wherein the spacing element extends along a terminal insert insertion direction.

10. The terminal insert according to claim 1, wherein the terminal insert comprises a base body, the base body comprising a first tube section at which the terminal receptacle is located and a second tube section at which at least a part of the insert receptacle fitting section is located.

11. The terminal insert according to claim 10, wherein the base body comprises a third tube section between the first tube section and the second tube section.

12. The terminal insert according to claim 11, wherein the terminal insert comprises at least one spacing element adapted for spacing the remainder of the terminal insert from an inner wall of the insert receptacle, the spacing element extending along the second tube section and the third tube section.

13. The terminal insert according to claim 1, wherein the terminal insert comprises a stop face facing in the terminal insert insertion direction.

14. A connector comprising:
a terminal insert for an unshielded cable, the terminal insert including an insert receptacle fitting section, a terminal receptacle that is adapted to fittingly receive at least parts of a cable terminal, and a touch protection section at least at a first end, wherein the insert receptacle fitting section and the touch protection section are located on one monolithic piece; and
an insert receptacle adapted to mate with the terminal insert and with at least one further terminal insert, wherein the insert receptacle fitting section is adapted to be fittingly received in at least a part of the insert receptacle.

15. The connector according to claim 14, wherein the terminal receptacle is substantially complementary to the parts of the cable terminal.

16. The connector according to claim 14, wherein the terminal insert further comprises at least one terminal insert securing element for securing the terminal insert to the insert receptacle.

17. The connector according to claim 14, wherein the terminal insert further comprises at least one cable terminal securing element for securing the cable terminal to the terminal insert.

18. The connector according to claim 14, wherein the terminal insert comprises at least one spacing element adapted for spacing the remainder of the terminal insert from an inner wall of the insert receptacle.

19. The connector according to claim 14, wherein the terminal insert comprises a base body, the base body comprising a first tube section at which the terminal receptacle is located and a second tube section at which at least a part of the insert receptacle fitting section is located.

20. A set comprising:
a connector comprising an insert receptacle, a terminal insert for an unshielded cable, and a further terminal insert for a shielded cable,
the terminal insert includes an insert receptacle fitting section that is adapted to be fittingly received in at least a part of the insert receptacle, a terminal receptacle that is adapted to fittingly receive at least parts of a cable terminal of the unshielded cable, and a touch protection section at least at a first end, wherein the insert receptacle fitting section and the touch protection section are located on one monolithic piece;
the further terminal insert includes a shielding part that is configured to be connected to a shielding of the shielded cable; and
the insert receptacle is configured to receive selectively the terminal insert or the further terminal insert.
